(19) United States
(12) Patent Application Publication
(10) Pub. No.: US 2021/0215869 A1
(43) Pub. Date: Jul. 15, 2021

(54) PRODUCTION LEVELING APPARATUS FOR PREVENTING WARP OF LIGHT GUIDE FILM

(71) Applicant: NANJING BREADY ELECTRONICS CO., LTD., Nanjing (CN)

(72) Inventor: Yong LIU, Nanjing (CN)

(21) Appl. No.: 16/965,759

(22) PCT Filed: Jun. 10, 2020
(86) PCT No.: PCT/CN2020/095415

§ 371 Date: Jul. 29, 2020

(30) Foreign Application Priority Data
Dec. 13, 2019 (CN) 201911297047.8

(51) Int. Cl. F21V 8/00; B29C 53/18; B29D 11/00

(52) U.S. Cl. CPC G02B 6/0065; B29D 11/00663; B29C 53/18

(57) ABSTRACT

The present invention provides a production leveling apparatus for preventing warp of a light guide film, including: a fixed support mechanism, a sliding support mechanism, and a tension detection mechanism oppositely disposed, wherein the tension detection mechanism is disposed on a surface of the light guide film, and the fixed support mechanism is provided with a drive mechanism for driving the slidable support mechanism to slide. In the present invention, the drive mechanism mounted on the fixed support mechanism drives the slidable support mechanism to slide, so that the slidable support mechanism drives a guide shaft to move with respect to a rolling shaft; moreover, the tension detection mechanism performs tension detection on the light guide film, so that the surface tension of the light guide film is within a reasonable range; the cooperative usage of the infrared signal transmitter and the infrared signal receiver implements accurate horizontal detection on the light guide film; adjusting the height of a guide shaft by means of a lifting assembly further ensures that the light guide film is in a horizontal state and prevents the light guide film from being damaged and warped, so that the quality of the light guide film is ensured; the structure design is reasonable and simple, and the usage is convenient.

### TECHNICAL FIELD

The present invention relates to the field of light guide films, and in particular, to a production leveling apparatus for preventing warp of a light guide film.

### BACKGROUND

Light guide net points are generally processed on a light guide plate by means of injection molding, hot pressing or printing; however, the conventional injection molding and ejection molding would be hard to implement the thin film design of the light guide plate; a current mode for preparing the light guide film gradually trends towards an integrated design and one-step forming, simplifies the light guide film preparing procedure, and saves costs, and therefore, extrusion molding is a preferable mode for preparing the light guide film.

Chinese Invention Patent CN207224639U discloses a light guide film manufacturing facility, comprising a feed inlet, a melt mixing region, a mixing blade, a punch head, a first polygon rolling shaft, a controller, a guide wheel, a second polygon rolling shaft, a guide working platform, a cutting plate, an air pump, a cutting edge, a screw rod, a motor, a finished product collection region, and a sliding grinding block. The polygon rolling shafts are used for performing extrusion manufacturing on raw materials, which avoids a warping phenomenon caused by a round rolling shaft; next, to eliminate uneven phenomenon of the light guide film caused by an uneven applied force during a cutting process or expansion caused by heat and contraction caused by cold during a delivering process, at the last stage, the screw rod drives the sliding grinding block to perform the last grinding on the light guide film, ensuring the flatness of the plane of the light guide film.

In the patent and prior art above, during the light guide film transmission process, when it is converted from a vertical state to a horizontal state, the light guide film is damaged and warped by a sliding grinding block due to the insufficiently horizontal light guide film, and changes in the surface tension of the light guide film during the delivering process would easily cause the light guide film to be dragged, damaged, and warped, so as to greatly reduce the quality of the light guide film.

### SUMMARY

The purpose of the present invention is to provide a production leveling apparatus for preventing warp of a light guide film, solves the problem that during the light guide film transmission process, when it is converted from a vertical state to a horizontal state, the light guide film is damaged and warped by a sliding grinding block due to the insufficiently horizontal light guide film, or changes in the surface tension of the light guide film would easily cause the light guide film to be dragged, damaged, and warped, so as to greatly reduce the quality of the light guide film.

To achieve the purpose above, the present invention provides the following technical solution: a production leveling apparatus for preventing warp of a light guide film, including: a fixed support mechanism, a sliding support mechanism, and a tension detection mechanism oppositely disposed, where the tension detection mechanism is disposed on a surface of the light guide film; the fixed support mechanism is provided with a drive mechanism for driving the slidable support mechanism to slide; the fixed support mechanism includes a fixed rack and support plates; the support plates are fixedly connected to two sides of the fixed rack; a rolling shaft is fixedly connected between the two support plates by means of a connection shaft; the connection shaft of the rolling shaft is connected to an infrared signal receiver by means of a shaft sleeve; and the infrared signal receiver is fixedly connected to the support plates;

the slidable support mechanism includes a support part and a lifting assembly; a guide shaft is fixedly connected on the lifting assembly by means of a connection shaft; the support part and a lifting assembly are cooperatively used for adjusting a separation distance between the guide shaft and the rolling shaft; the lifting assembly is configured to support and adjust the height of the guide shaft; the connection shaft of the guide shaft is connected to an infrared signal transmitter by means of a shaft sleeve; the infrared signal transmitter is fixedly connected to the support part; and the infrared signal transmitter and the infrared signal receiver are cooperatively used; and

the drive mechanism includes a second servo motor mounted on the fixed rack by means of a mounting rack; an output shaft of the second servo motor is fixedly connected to a threaded rod; the threaded rod is threadedly connected with a threaded pipe; an end of the threaded pipe away from the threaded rod is fixedly connected to the support part; two sides of the support part are provided with a limiting mechanism; and the limiting mechanism is fixedly connected to the fixed rack.

Moreover, in the present invention, the support part includes a support box, limiting blocks, and shaft connection plates; the limiting mechanism includes limiting guide rails; the number of the limiting guide rails is two; the limiting guide rails are disposed at two sides of the support box; an end of each limiting guide rail is fixedly connected to the fixed rack; the limiting blocks are fixedly connected to two sides of the support box; the support box is slidably connected in a sliding slot of each limiting guide rail by means of the limiting block; the shaft connection plate is fixedly connected to the top of the support box and is movably connected to the guide shaft by means of the connection shaft; the bottom of the shaft connection plate is fixedly connected to the support box; and a side of the support box is connected to an end of the threaded rod by means of a bearing.

Moreover, in the present invention, the lifting assembly includes a lifting part, a transmission part, and a first servo motor; the first servo motor drives the lifting and lowering of the lifting part by means of the transmission part; the lifting part includes a support rack, a sliding rail, a lifting plate, and a connection rack; the transmission part includes a first gear, a second gear, a special-shaped wheel, a first wheel carrier, a first taper wheel, a second wheel carrier, a second taper wheel, a rotation shaft, and a connection sleeve; an output shaft of the first servo motor is fixedly connected to the first gear by means of a coupler; the first gear is engaged with the second gear; an axial length of the first gear is greater than an axial length of the second gear; the second gear is sleeved on a surface of the special-shaped wheel; the top and bottom of the special-shaped wheel are each provided with an arc-shaped inclined surface with a height difference; the top and bottom of the special-shaped wheel are symmetric; the first taper wheel and the second taper wheel are respectively disposed at the top and bottom of the special-shaped wheel; the surface of the first taper wheel is in contact with the top of the special-shaped wheel; the surface of the second taper wheel is in contact with the bottom of the special-shaped wheel; the first taper wheel is movably disposed in the first wheel carrier by means of a spindle; the second taper wheel is movably disposed in the second wheel carrier by means of a spindle; the bottom of the rotation shaft is movably connected to the bottom of an inner cavity of the support box by means of a bearing seat; the connection sleeve is sleeved on the surface of the rotation shaft; and the connection sleeve is fixed at an inner cavity of the special-shaped wheel.

The bottom of the support rack is fixedly connected to the bottom of the inner cavity of the support box; the sliding rail is fixedly connected to the surface of the support rack; the bottom of the lifting plate runs through the sliding rail; the top of the lifting plate is fixedly connected to the connection rack; the top of the connection rack runs through the top of the support box and is movably connected to a side edge of the guide shaft by means of a bearing; the first wheel carrier is fixedly connected to the lifting plate; and the bottom of the second wheel carrier is fixedly connected to the bottom of the inner cavity of the support box.

Furthermore, in the present invention, sliding blocks are fixedly connected to two sides of the lifting plate; and sliding slots adapted to the sliding blocks are disposed at two sides of the inner cavity of the sliding rail.

Furthermore, in the present invention, the number of the connection racks is two; and the top of the support box is provided with through holes adapted to the connection racks.

Furthermore, in the present invention, reinforcement rods are fixedly connected to the bottom of the fixed rack in a width direction; and the number of the reinforcement rods is not less than two.

Furthermore, in the present invention, a tension sensor and an infrared sensor are further included; the infrared signal receiver is electrically connected to the infrared sensor; and the tension sensor is electrically connected to the tension detection mechanism.

Furthermore, in the present invention, a PLC controller, a wireless communication module, a voice module, and an alarm device are further included.

Furthermore, in the present invention, the tension sensor and the infrared sensor are both connected to the PLC controller by means of the wireless communication module; and the PLC controller controls the first servo motor, the second servo motor, the voice module, and the alarm device.

Furthermore, in the present invention, the tension detection mechanism is an SYD-6541A typed fully automatic interface tension meter.

Regarding the beneficial effects, the technical solution of the present application has the following technical effects:

1. In the present invention, the drive mechanism mounted on the fixed support mechanism drives the slidable support mechanism to slide, so that the slidable support mechanism drives a guide shaft to move with respect to a rolling shaft; moreover, the tension detection mechanism performs tension detection on the light guide film, so that the surface tension of the light guide film is within a reasonable range; the cooperative usage of the infrared signal transmitter and the infrared signal receiver implements accurate horizontal detection on the light guide film; adjusting the height of the guide shaft by means of the lifting assembly further ensures that the light guide film is in a horizontal state, prevents the light guide film from a phenomenon of damaged and warped, and ensures the quality of the light guide film; the structure design is reasonable and simple, and the usage is convenient, thus having strong practicability.

2. In the present invention, intelligentization control can be implemented by means of the PLC controller; the tension sensor and the infrared sensor send the detection result to the PLC controller by means of the wireless communication module; the PLC controller processes and controls the voice module and the alarm device, so as to achieve the purpose of adjusting the light guide film to be horizontal and adjusting the tension; moreover, setting the voice module and the alarm device can implement voice prompting and alarming functions, which is more humanized and brings conveniences to a user.

3. In the present invention, setting the reinforcement rods can increase stability of the fixed rack, so that the support by the fixed rack is more stable, which facilitates normal usage of an apparatus and facilitates extension of the service life of the apparatus.

It should be understood that all combinations of the foregoing concepts and additional concepts described below in detail can be considered as part of the subject matter of invention of the present disclosure as long as such concepts do not contradictory to each other.

The foregoing and other aspects, embodiments, and features taught in the present invention can be more fully understood from the following description in conjunction with the accompanying drawings. Other additional aspects of the present invention, such as features and/or beneficial effects of the exemplary embodiments, are apparent in the following description, or are obtained from the practice of specific embodiments taught in the present invention.

### BRIEF DESCRIPTION OF THE DRAWINGS

The drawings are not intended to be drawn to scale. In the drawings, each identical or approximately identical component shown in each drawing can be denoted by the same reference numeral. For the sake of clarity, not every component is marked in each drawing. Now, embodiments of various aspects of the present invention are described by examples and with reference to the drawings, in which:

FIG. 1 is a schematic diagram of a structure of the present invention.

FIG. 2 is an upward view of a certain angle of view of the bottom of the present invention.

FIG. 3 is a stereoscopic view of an angle of view of a side of the present invention.

FIG. 4 is a sectional view of a local structure of the present invention.

FIG. 5 is a stereoscopic view of a lifting assembly of the present invention.

FIG. 6 is a front view of the lifting assembly of the present invention.

FIG. 7 is a schematic diagram of system control of the present invention.

In the drawings, the meaning for each reference numeral is: 1, fixed rack; 2, support plate; 3, rolling shaft; 4, guide shaft; 5, support part; 501, support box; 502, limiting block; 503, limiting guide rail; 504, shaft connection plate; 6, lifting assembly; 601, lifting part; 602, transmission part; 603, first servo motor; 6011, support rack; 6012, sliding rail; 6013, lifting plate; 6014, connection rack; 6021, first gear; 6022, second gear; 6023, special-shaped wheel; 6024, first wheel carrier; 6025, first taper wheel; 6026, second wheel carrier; 6027, second taper wheel; 6028, rotation shaft; 6029, connection sleeve; 7, infrared signal transmitter; 8, infrared signal receiver; 9, second servo motor; 10, threaded rod; 11, threaded pipe; 12, tension detection mechanism; 13, reinforcement rod; 14, light guide film; 15, PLC controller; 16, wireless communication module; 17, tension senor; 18, infrared sensor; 19, voice module; and 20, alarm device.

### DETAILED DESCRIPTION

In order to better understand the technical content of the present invention, specific embodiments are specially listed, and are described below in conjunction with the accompanying drawings.

Various aspects of the present invention are described in the present disclosure with reference to the accompanying drawings, in which many illustrated embodiments are shown. The embodiments of the present disclosure are not defined to include all aspects of the present invention. It should be understood that various concepts and embodiments described above, as well as those concepts and embodiments described below in detail can be implemented in any of many ways, because the concepts and embodiments disclosed in the present invention do not limited to any embodiment. In addition, some aspects of the present disclosure may be used alone or in any appropriate combination with other aspects of the present disclosure.

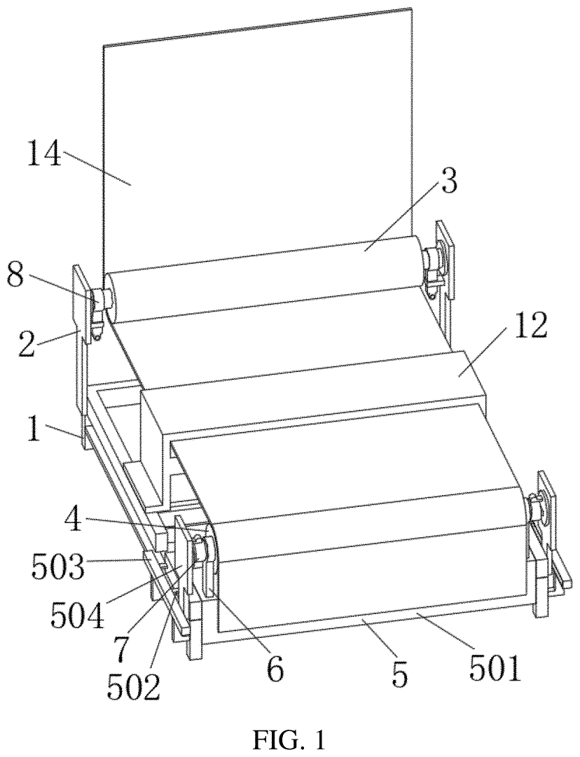

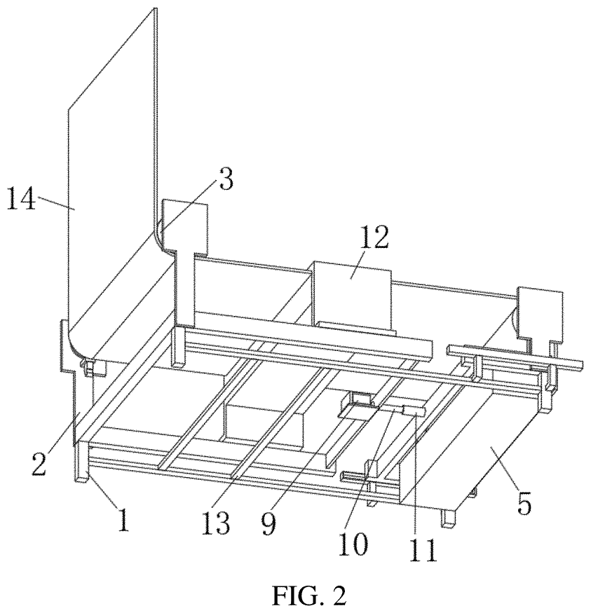

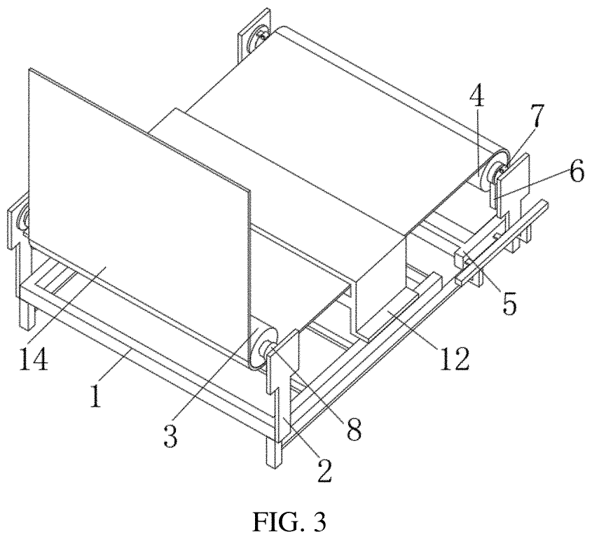

As shown in FIGS. 1-4, a production leveling apparatus for preventing warp of a light guide film includes a fixed support mechanism, a sliding support mechanism, and a tension detection mechanism 12 oppositely disposed, where the tension detection mechanism 12 is disposed on a surface of the light guide film 14; the fixed support mechanism is provided with a drive mechanism for driving the slidable support mechanism to slide; the fixed support mechanism includes a fixed rack 1 and support plates 2; reinforcement rods 13 are fixedly connected to the bottom of the fixed rack 1 in a width direction; the number of the reinforcement rods 13 is not less than two; the support plates 2 are fixedly connected to two sides of the fixed rack 1; a rolling shaft 3 is fixedly connected between the two support plates 2 by means of a connection shaft; the connection shaft of the rolling shaft 3 is connected to an infrared signal receiver 8 by means of a shaft sleeve; and the infrared signal receiver 8 is fixedly connected to the support plates 2. The slidable support mechanism includes a support part 5 and a lifting assembly 6; a guide shaft 4 is fixedly connected on the lifting assembly 6 by means of a connection shaft; the support part 5 and a lifting assembly 6 are cooperatively used for adjusting a separation distance between the guide shaft 4 and the rolling shaft 3; the lifting assembly 6 is configured to support and adjust the height of the guide shaft 4; the connection shaft of the guide shaft 4 is connected to an infrared signal transmitter 7 by means of a shaft sleeve; the infrared signal transmitter 7 is fixedly connected to the support part 5; the infrared signal transmitter 7 and the infrared signal receiver 8 are cooperatively used; and the infrared signal transmitter 7 and the infrared signal receiver 8 are respectively leveled by using a previous gradienter.

The drive mechanism includes a second servo motor 9 mounted on the fixed rack 1 by means of a mounting rack; an output shaft of the second servo motor 9 is fixedly connected to a threaded rod 10; the threaded rod 10 is threadedly connected with a threaded pipe 11; an end of the threaded pipe 11 away from the threaded rod 10 is fixedly connected to the support part 5; two sides of the support part 5 are provided with a limiting mechanism; and the limiting mechanism is fixedly connected to the fixed rack 1.

A tension sensor 17 and an infrared sensor 18 are further included; the infrared signal receiver 8 is electrically connected to the infrared sensor 18; and the tension sensor 17 is electrically connected to the tension detection mechanism 12; a PLC controller 15, a wireless communication module 16, a voice module 19, and an alarm device 20 are further included; the tension sensor 17 and the infrared sensor 18 are both connected to the PLC controller 15 by means of the wireless communication module 16; and the PLC controller 15 controls the first servo motor 603, the second servo motor 9, the voice module 19, and the alarm device 20.

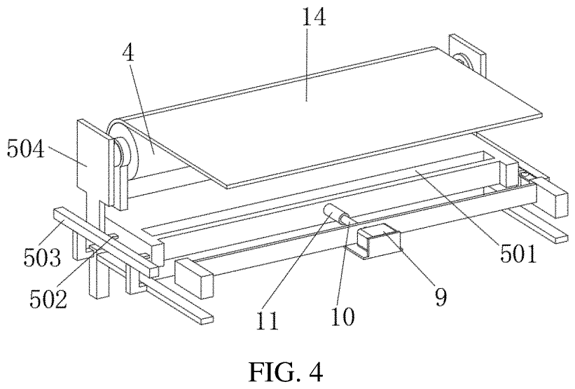

As shown in FIGS. 4-6, moreover, in the present invention, the support part 5 includes a support box 501, limiting blocks 502, and shaft connection plates 504; the limiting mechanism includes limiting guide rails 503; the number of the limiting guide rails 503 is two; the limiting guide rails 503 are disposed at two sides of the support box 501; an end of each limiting guide rail 503 is fixedly connected to the fixed rack 1; the limiting blocks 502 are fixedly connected to two sides of the support box 501; the support box 501 is slidably connected in a sliding slot of each limiting guide rail 503 by means of the limiting block 502; the shaft connection plate 504 is fixedly connected to the top of the support box 501 and is movably connected to the guide shaft 4 by means of the connection shaft; the bottom of the shaft connection plate 504 is fixedly connected to the support box 501; and a side of the support box 501 is connected to an end of the threaded rod 10 by means of a bearing.

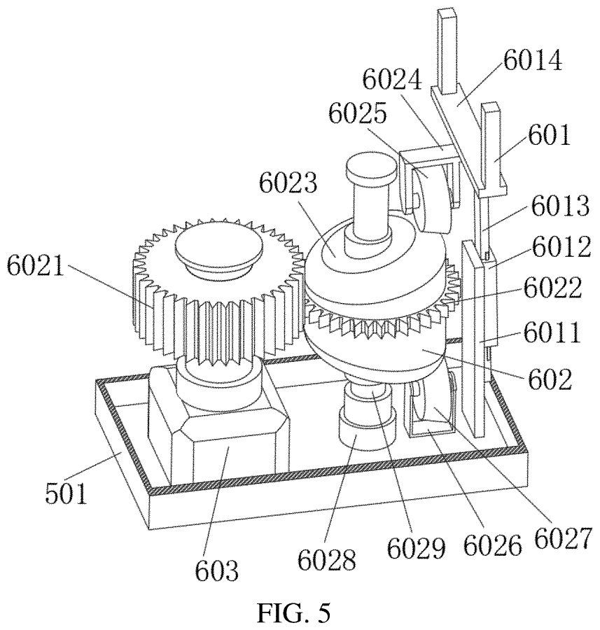

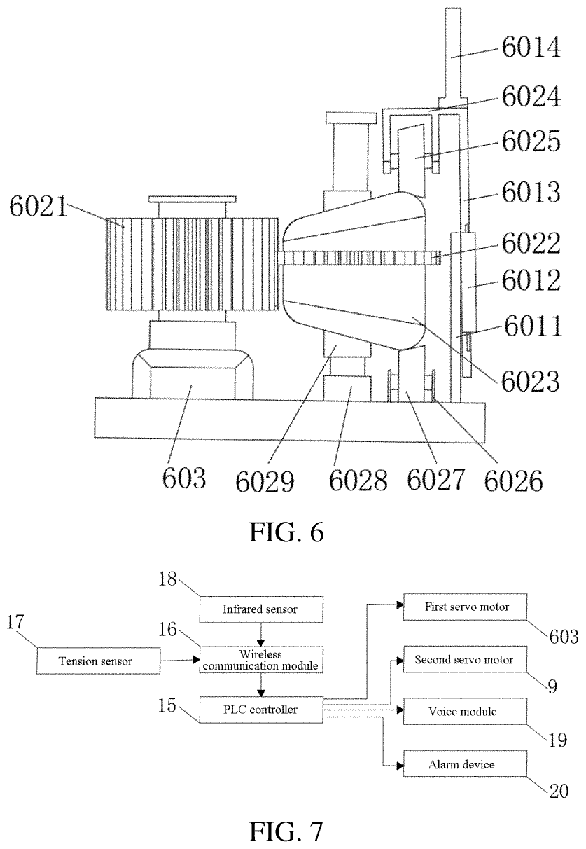

As shown in FIGS. 5 and 6, moreover, in the present invention, the lifting assembly 6 includes a lifting part 601, a transmission part 602, and a first servo motor 603; the first servo motor 603 drives the lifting and lowering of the lifting part 601 by means of the transmission part 602; the lifting part 601 includes a support rack 6011, a sliding rail 6012, a lifting plate 6013, and a connection rack 6014; the transmission part 602 includes a first gear 6021, a second gear 6022, a special-shaped wheel 6023, a first wheel carrier 6024, a first taper wheel 6025, a second wheel carrier 6026, a second taper wheel 6027, a rotation shaft 6028, and a connection sleeve 6029; an output shaft of the first servo motor 603 is fixedly connected to the first gear 6021 by means of a coupler; the first gear 6021 is engaged with the second gear 6022; an axial length of the first gear 6021 is greater than an axial length of the second gear 6022; the second gear 6022 is sleeved on a surface of the special-shaped wheel 6023; the top and bottom of the special-shaped wheel 6023 are each provided with an arc-shaped inclined surface with a height difference; the top and bottom of the special-shaped wheel 6023 are symmetric; the first taper wheel 6025 and the second taper wheel 6027 are respectively disposed at the top and bottom of the special-shaped wheel 6023; the surface of the first taper wheel 6025 is in contact with the top of the special-shaped wheel 6023; the surface of the second taper wheel 6027 is in contact with the bottom of the special-shaped wheel 6023; the first taper wheel 6025 is movably disposed in the first wheel carrier 6024 by means of a spindle; the second taper wheel 6027 is movably disposed in the second wheel carrier 6026 by means of a spindle; the bottom of the rotation shaft 6028 is movably connected to the bottom of an inner cavity of the support box 501 by means of a bearing seat; the connection sleeve 6029 is sleeved on the surface of the rotation shaft 6028; and the connection sleeve 6029 is fixed at an inner cavity of the special-shaped wheel 6023.

The bottom of the support rack 6011 is fixedly connected to the bottom of the inner cavity of the support box 501; the sliding rail 6012 is fixedly connected to the surface of the support rack 6011; the bottom of the lifting plate 6013 runs through the sliding rail 6012; the top of the lifting plate 6013 is fixedly connected to the connection rack 6014; the top of the connection rack 6014 runs through the top of the support box 501 and is movably connected to a side edge of the guide shaft 4 by means of a bearing; the first wheel carrier 6024 is fixedly connected to the lifting plate 6013; and the bottom of the second wheel carrier 6026 is fixedly connected to the bottom of the inner cavity of the support box 501.

Furthermore, in this embodiment, sliding blocks are fixedly connected to two sides of the lifting plate 6013; and sliding slots adapted to the sliding blocks are disposed at two sides of the inner cavity of the sliding rail 6012.

Furthermore, in this embodiment, the number of the connection racks 6014 is two; and the top of the support box 501 is provided with through holes adapted to the connection racks 6014.

During usage of the present invention, the tension detection mechanism 12 detects the tension on the surface of the light guide film 14, and transmits to the wireless communication module 16 by means of the tension sensor 17; the infrared signal transmitter 7 issues an infrared signal; the infrared signal receiver 8 receives the signal for detecting whether the light guide film 14 is in a horizontal state, and transmits to the wireless communication module 16 by means of the infrared sensor 18; when the light guide film 14 is in a non-horizontal state or the surface tension is in an abnormal state, the wireless communication module 16 controls the voice module 19 to issue a voice prompt, alarms by means of the alarm device 20, and controls the first servo motor 603 and the second servo motor 9 at the same time.

When in the non-horizontal state, the PLC controller 15 controls the first servo motor 603 to start; the output shaft of the first servo motor 603 drives the first gear 6021 to rotate; the first gear 6021 is engaged with the second gear 6022; the first gear 6021 drives, by means of the second gear 6022, the special-shaped wheel 6023 to rotate; since the top and bottom of the special-shaped wheel 6023 are both an inclined face having a height difference, the bottom of the special-shaped wheel 6023 is provided with the second taper wheel 6027; when a higher end of the bottom of the special-shaped wheel 6023 rotates to contact the second taper wheel 6027; the special-shaped wheel 6023 ascends; the special-shaped wheel 6023 ascends for a certain distance from the surface of the rotation shaft 6028 by means of the connection sleeve 6029; the top of the special-shaped wheel 6023 is in contact with the first taper wheel 6025; the first taper wheel 6025 drives, by means of the first wheel carrier 6024, the lifting plate 6013 to ascend; the lifting plate 6013 drives the connection rack 6014 to ascend; the connection rack 6014 drives the guide shaft 4 to ascend until the infrared signal transmitter 7 and the infrared signal receiver 8 are located on a horizontal plane; the infrared sensor 18 transmits the signal to the PLC controller 15; the PLC controller 15 controls the first servo motor 603 to close; similarly, when the guide shaft 4 is required to descend, the first servo motor 603 can be reversely rotated.

When the surface tension is in the abnormal state, the PLC controller 15 controls the second servo motor 9 to start; the output shaft of the second servo motor 9 drives the threaded rod 10 to rotate; the threaded rod 10 is threadedly connected to the threaded pipe 11; the threaded pipe 11 drives the support box 501 to move; the support box 501 slides on the surface of the limiting guide rail 503 by means of the limiting block 502; the limiting guide rail 503 acts as limiting the support box 501; the support box 501 moves to drive the lifting assembly 6 to move; the lifting assembly 6 drives the guide shaft 4 to adjust the distance to the rolling shaft 3, so as to adjust the tension of the surface of the light guide film 14, so that the surface tension of the light guide film 14 is in a normal range; the tension sensor 17 sends the detection result to the PLC controller 15; and the PLC controller 15 controls the second servo motor 9 to stop operation.

The present invention does not require manual intervention, it relates to fully automatic control, saves time an force, is simple and fast, and brings great convenience to the user, which greatly improves the quality of the light guide film 14, improves the manufacturing efficiency, and facilitates enterprise revenues.

In the present invention, the drive mechanism mounted on the fixed support mechanism drives the slidable support mechanism to slide, so that the slidable support mechanism drives a guide shaft 4 to move with respect to a rolling shaft 3; moreover, the tension detection mechanism 12 performs tension detection on the light guide film 14, so that the surface tension of the light guide film 14 is within a reasonable range; the cooperative usage of the infrared signal transmitter 7 and the infrared signal receiver 8 implements accurate horizontal detection on the light guide film 14; adjusting the height of the guide shaft 4 by means of the lifting assembly 6 further ensures that the light guide film 14 is in a horizontal state, prevents the light guide film 14 from a phenomenon of damaged and warped, and ensures the quality of the light guide film 14; the structure design is reasonable and simple, and the usage is convenient, thus having strong practicability.

Intelligentization control can be implemented by means of the PLC controller 15; the tension sensor 17 and the infrared sensor 18 send the detection result to the PLC controller 15 by means of the wireless communication module 16; the PLC controller 15 processes and controls the voice module 19 and the alarm device 20, so as to achieve the purpose of adjusting the light guide film 14 to be horizontal and adjusting the tension; moreover, setting the voice module 19 and the alarm device 20 can implement voice prompting and alarming functions, which is more humanized and brings conveniences to a user.

Electrical components in the present application are all connected to an electric supply by means of power lines (not drawn in the drawings). A circuit and control involved in the present invention are both prior art, and are not described herein with unnecessary details.

Although the present invention is disclosed above with preferred embodiments, the present invention is not limited thereto. Those of ordinary knowledge in the technical field to which the present invention belongs can make various changes and modifications without departing from the spirit and scope of the present invention. Therefore, the scope of protection of the present invention should be subject to the scope defined by the appended claims.

1. A production leveling apparatus for preventing warp of a light guide film, comprising: a fixed support mechanism, a sliding support mechanism, and a tension detection mechanism oppositely disposed, wherein the tension detection mechanism is disposed on a surface of the light guide film; the fixed support mechanism is provided with a drive mechanism for driving the slidable support mechanism to slide; the fixed support mechanism comprises a fixed rack and support plates; the support plates are fixedly connected to two sides of the fixed rack; a rolling shaft is fixedly connected between the two support plates by means of a connection shaft; the connection shaft of the rolling shaft is connected to an infrared signal receiver by means of a shaft sleeve; and the infrared signal receiver is fixedly connected to the support plates;
the slidable support mechanism comprises a support part and a lifting assembly; a guide shaft is fixedly connected on the lifting assembly by means of a connection shaft; the support part and the lifting assembly are cooperatively used for adjusting a separation distance between the guide shaft and the rolling shaft; the lifting assembly is configured to support and adjust the height of the guide shaft; the connection shaft of the guide shaft is connected to an infrared signal transmitter by means of a shaft sleeve; the infrared signal transmitter is fixedly connected to the support part; and the infrared signal transmitter and the infrared signal receiver are cooperatively used; and
the drive mechanism comprises a second servo motor mounted on the fixed rack by means of a mounting rack; an output shaft of the second servo motor is fixedly connected to a threaded rod; the threaded rod is threadedly connected with a threaded pipe; an end of the threaded pipe away from the threaded rod is fixedly connected to the support part; two sides of the support part are provided with a limiting mechanism; and the limiting mechanism is fixedly connected to the fixed rack.

2. The production leveling apparatus for preventing warp of a light guide film according to claim 1, wherein the support part comprises a support box, limiting blocks, and shaft connection plates; the limiting mechanism comprises limiting guide rails; the number of the limiting guide rails is two; the limiting guide rails are disposed at two sides of the support box; an end of each limiting guide rail is fixedly connected to the fixed rack; the limiting blocks are fixedly connected to two sides of the support box; the support box is slidably connected in a sliding slot of each limiting guide rail by means of the limiting block; the shaft connection plate is fixedly connected to the top of the support box and is movably connected to the guide shaft by means of the connection shaft; the bottom of the shaft connection plate is fixedly connected to the support box; and a side of the support box is connected to an end of the threaded rod by means of a bearing.

3. The production leveling apparatus for preventing warp of a light guide film according to claim 2, wherein the lifting assembly comprises a lifting part, a transmission part, and a first servo motor; the first servo motor drives the lifting and lowering of the lifting part by means of the transmission part; the lifting part comprises a support rack, a sliding rail, a lifting plate, and a connection rack; the transmission part comprises a first gear, a second gear, a special-shaped wheel, a first wheel carrier, a first taper wheel, a second wheel carrier, a second taper wheel, a rotation shaft, and a connection sleeve; an output shaft of the first servo motor is fixedly connected to the first gear by means of a coupler; the first gear is engaged with the second gear; an axial length of the first gear is greater than an axial length of the second gear; the second gear is sleeved on a surface of the special-shaped wheel; the top and bottom of the special-shaped wheel are each provided with an arc-shaped inclined surface with a height difference; the top and bottom of the special-shaped wheel are symmetric; the first taper wheel and the second taper wheel are respectively disposed at the top and bottom of the special-shaped wheel; the surface of the first taper wheel is in contact with the top of the special-shaped wheel; the surface of the second taper wheel is in contact with the bottom of the special-shaped wheel; the first taper wheel is movably disposed in the first wheel carrier by means of a spindle; the second taper wheel is movably disposed in the second wheel carrier by means of a spindle; the bottom of the rotation shaft is movably connected to the bottom of an inner cavity of the support box by means of a bearing seat; the connection sleeve is sleeved on the surface of the rotation shaft; and the connection sleeve is fixed at an inner cavity of the special-shaped wheel; and
the bottom of the support rack is fixedly connected to the bottom of the inner cavity of the support box; the sliding rail is fixedly connected to the surface of the support rack; the bottom of the lifting plate runs through the sliding rail; the top of the lifting plate is fixedly connected to the connection rack; the top of the connection rack runs through the top of the support box and is movably connected to a side edge of the guide shaft by means of a bearing; the first wheel carrier is fixedly connected to the lifting plate; and the bottom of the second wheel carrier is fixedly connected to the bottom of the inner cavity of the support box.

4. The production leveling apparatus for preventing warp of a light guide film according to claim 3, wherein sliding blocks are fixedly connected to two sides of the lifting plate; and sliding slots adapted to the sliding blocks are disposed at two sides of the inner cavity of the sliding rail.

5. The production leveling apparatus for preventing warp of a light guide film according to claim 4, wherein the number of the connection racks is two; and the top of the support box is provided with through holes adapted to the connection racks.

6. The production leveling apparatus for preventing warp of a light guide film according to claim 1, wherein reinforcement rods are fixedly connected to the bottom of the fixed rack in a width direction; and the number of the reinforcement rods is not less than two.

7. The production leveling apparatus for preventing warp of a light guide film according to claim 6, further comprising: a tension sensor and an infrared sensor; the infrared signal receiver is electrically connected to the infrared sensor; and the tension sensor is electrically connected to the tension detection mechanism.

8. The production leveling apparatus for preventing warp of a light guide film according to claim 1, further comprising: a PLC controller, a wireless communication module, a voice module, and an alarm device.

9. The production leveling apparatus for preventing warp of a light guide film according to claim 1, wherein the tension sensor and the infrared sensor are both connected to the PLC controller by means of the wireless communication module; and the PLC controller controls the first servo motor, the second servo motor, the voice module, and the alarm device.

10. The production leveling apparatus for preventing warp of a light guide film according to claim 1, wherein the tension detection mechanism is an SYD-6541A typed fully automatic interface tension meter.
